(19) United States
(12) Patent Application Publication
(10) Pub. No.: US 2016/0069651 A1
(43) Pub. Date: Mar. 10, 2016

(54) A SMARTPHONE ELECTROSHOCK FACILITY

(71) Applicant: Dafna GULL GAZIT, Raanana (IL)

(72) Inventor: DAFNA GULL GAZIT, RAANANA (IL)

(21) Appl. No.: 14/783,869

(22) PCT Filed: Jun. 5, 2014
(86) PCT No.: PCT/IL2014/050509

§ 371 Date: Oct. 12, 2015

(30) Foreign Application Priority Data
Jul. 28, 2013 (IL) 227672

(51) Int. Cl. F41H 13/00

(52) U.S. Cl. CPC F41H 13/0018

(57) ABSTRACT

A smartphone electroshock facility, comprising: a cover (10) of the smartphone (12), for storing therein an electroshock circuitry (16), for generating an electroshock; two electrodes (14), for administrating the electroshock; one or more activation buttons, for activating the electroshock circuitry to generate an electroshock; a safety catch mechanism employing the activation button, for preventing unintentional activation of the electroshock; a communication channel between the smartphone (12) and the electroshock circuitry (16), for controlling therethrough the electroshock circuitry (16) and activating therethrough the shock; and a power source (40, 48), for providing electrical power for generating the electroshock.

### TECHNICAL FIELD

The present invention relates to the field of self-defending devices. More particularly, the invention relates to a smartphone electroshock facility.

### BACKGROUND ART

A stun gun is a weapon which momentarily disables a person with an electric shock, but is not lethal. It operates by administering electric shock aimed at disrupting superficial muscle functions. Usually, stun guns are devices designed especially for this purpose, and cellular phones having become in widespread use, some attempts have been made to combine an electroshock device with a cellular phone.

U.S. Pat. No. 7,986,965 to Kroll et al. is considered the closest prior art. It introduces a cellular telephone combined with an electric shocker. FIG. 9 of this patent document “shows the high location of the safety switch. In order to enable the shocking circuitry the operator must depress the round switch 700 hard. This is difficult to do if the phone face is against the side of the head as it would be for normal phone usage. Thus this configuration reduces the risk of the operator shocking herself. The switch 700 could require a second operation of lifting a hood over it before it could be depressed. This would provide a double safety feature.”

Thus, the '965 patent deals with two opposing problems: ease of activating the shocker, and prevention of unintentional activation. One solution provided by the '965 patent is using an activation button that requires the operator thereof to “depress the round switch 700 hard”, and place the button on the center of the front side of a cellular phone, where it can be easily accessed in a situation in which the phone is held by one hand. However, this solution cannot be usable by smartphones, as the majority of smartphones have a front screen, and the buttons are not disposed at the center of the front, since it is occupied by the screen.

It is an object of the present invention to provide a solution to the above-mentioned and other problems of the prior art.

Other objects and advantages of the invention will become apparent as the description proceeds.

### SUMMARY OF THE INVENTION

In one aspect, the present invention is directed to a smartphone electroshock facility, comprising:
a cover (10) of the smartphone (12), for storing therein an electroshock circuitry (16), for generating an electroshock;
two electrodes (14), for administrating the electroshock;
one or more activation buttons, for activating the electroshock circuitry to generate an electroshock;
a safety catch mechanism employing the activation button, for preventing unintentional activation of the electroshock; and
a power source (40, 48), for providing electrical power for generating the electroshock.

According to one embodiment of the invention, the activation buttons (20) are disposed in opposite sides of the cover, and the circuitry is adapted to generate a shock if two or more of the buttons are pressed simultaneously, thereby preventing unintentional activation of the electroshock.

According to one embodiment of the invention, the safety catch mechanism includes an adaptation of the electroshock circuitry to sense whether two of the activation buttons (20) are pressed simultaneously for a period of at least three seconds.

According to one embodiment of the invention, the electrodes are disposed in a top side of the cover. According to another embodiment of the invention, A facility according to claim 1, wherein the electrodes are disposed in a bottom side of the cover.

According to one embodiment of the invention, the power source is a battery (48) disposed in the cover. According to another embodiment of the invention, the power source is a battery (40) of the smartphone (12).

According to one embodiment of the invention, the one or more activation buttons are physical buttons (20). According to another embodiment of the invention, the one or more activation buttons are physical buttons (34) of the smartphone. According to yet another embodiment of the invention, the one or more activation buttons are virtual buttons of the smartphone.

The cover (10) may cover only the lower part of the smartphone, thereby allowing connecting thereof only under expected danger, resulting in prevention of unintentional activation of an electroshock.

According to one embodiment of the invention, the safety catch mechanism is embodied as pressing the activation buttons in a predetermined order and period.

The facility may further comprise a software application (38) execute by the smartphone (12) and a communication channel (36, 46) between the smartphone and the circuitry, for controlling the electroshock circuitry (16) and activating the shock. The communication channel may be wired (36), wireless communication channel including an audio communication channel (46) such as employing DTMF signals.

When controlled by a smartphone, the safety catch mechanism may comprise an adaptation of the software application to sense whether a user holds his finger at the same place on a display of the smartphone while in a sleep state for a predetermined period.

According to one embodiment of the invention, the software application is adapted to send upon activating the electroshock an alerting message (e.g., by SMS—Short Messaging System) detailing a location of the smartphone to a predetermined addressee.

According to one embodiment of the invention, the software application controls a voltage generated between the electrodes (14) via a voltage in the input of an oscillator (28) of the electroshock circuitry (16).

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Preferred embodiments, features, aspects and advantages of the present invention are described herein in conjunction with the following drawings:

FIG. 1 schematically illustrates an electroshock system, according to one embodiment of the invention.

FIG. 2 schematically illustrates a smartphone 12 using the electroshock system of FIG. 1.

FIG. 3 schematically illustrates an electroshock system, according to another embodiment of the invention.

FIG. 4 schematically illustrates a smartphone 12 using the cover 10 of FIG. 3.

FIG. 5 is a block diagram schematically illustrating the major components of the embodiment of FIGS. 3 and 4.

FIG. 6 is a block diagram schematically illustrating the major components of a further embodiment of the invention.

FIG. 7 schematically illustrates an electroshock circuitry, according to one embodiment of the invention.

It should be understood that the drawings are not necessarily drawn to scale.

### DESCRIPTION OF EMBODIMENTS

The present invention will be understood from the following detailed description of preferred embodiments (“best mode”), which are meant to be descriptive and not limiting. For the sake of brevity, some well-known features, methods, systems, procedures, components, circuits, and so on, are not described in detail.

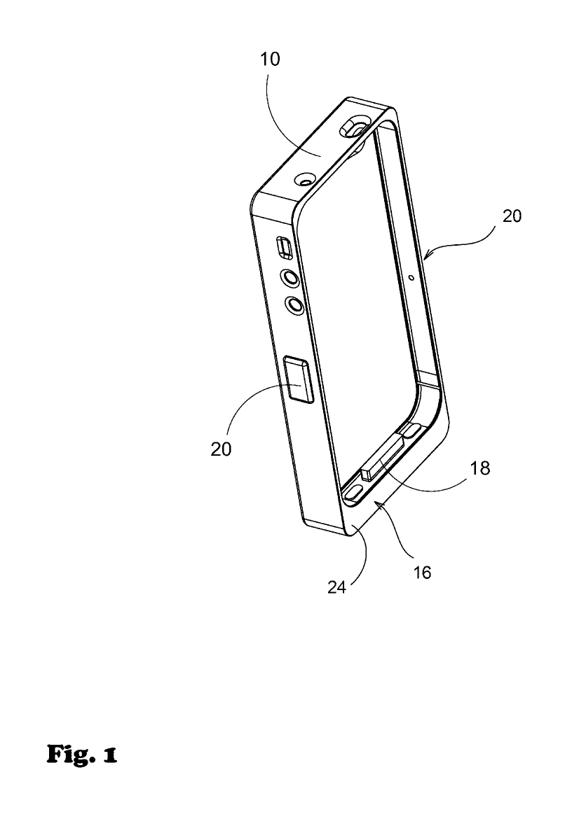

FIG. 1 schematically illustrates an electroshock system, according to one embodiment of the invention.

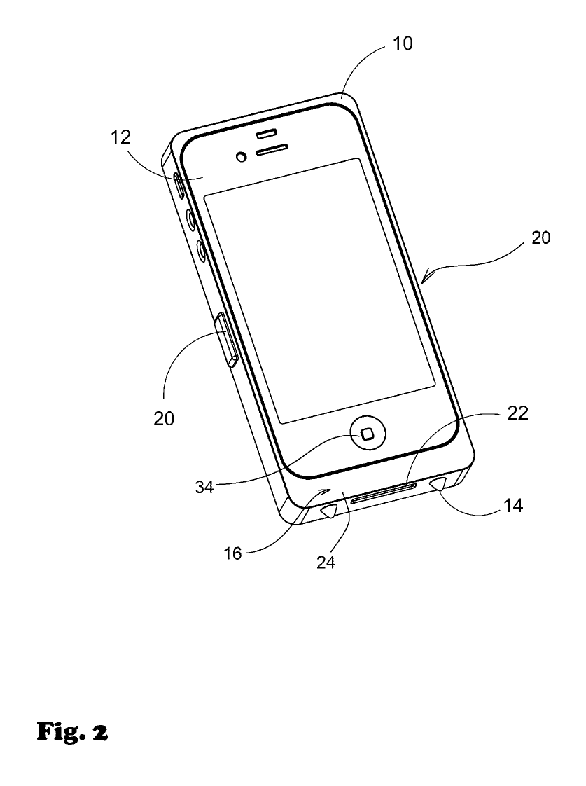

FIG. 2 schematically illustrates a smartphone 12 using the electroshock system of FIG. 1.

The electroshock system comprises a smartphone cover 10, which has an additional space 24 at the lower side thereof, for containing therein an electroshock circuitry 16. The circuitry is not seen in these figures (FIGS. 1 and 2), as it is disposed inside the smartphone cover.

The system comprises one or more activation buttons 20, disposed at opposing sides of cover 10. The shock is administrated by electrodes 14, which are disposed at the bottom side of the cover.

The electric power for generating a shock can be provided either by a dedicated battery disposed in the cover, or by the battery of the smartphone. In the latter case, cover 10 comprises a male connector 18, corresponding to the female connector of the smartphone, through which circuitry 16 connects to the battery of the smartphone. The battery of the smartphone is not seen in these figures.

According to one embodiment of the invention, cover 10 comprises two physical buttons 20, disposed at opposite sides of the cover, for activating a shock. By using two buttons simultaneously, each on an opposite side of the smartphone, two opposing objects are obtained: ease of use, and prevention of unintentional activation. Thus, in an emergency situation, a user grabs the smartphone with his palm from both sides thereof, thereby generating a shock. In order to affect an object such as a person assaulting the smartphone user, electrodes 14 must touch the object.

The chance of unintentional activation is increased if the buttons are “hard”, i.e., activated by a “higher” pressing power in comparison to a “common” pressing power. For instance, an example of a “hard” button is button 34 of Apple's iPhone.

The shocker can be further designed to prevent unintentional activation by adding a safety catch mechanism, in which the shocker enters into a standby state. For example, in order to enter into a standby state, the user must simultaneously press buttons 20 for a period of 5 seconds. When the shocker enters into the standby state, the user is alerted by a signal, such as an audio sound, a vibration of the phone, and so on. Then, he releases both buttons. When he wants to activate a shock, he again presses the buttons simultaneously for a “short” period, such as 1 second. If he keeps pressing the buttons for instance, for 5 seconds, the device exits the standby state.

In FIGS. 1 and 2, electrodes 14 are disposed at the bottom side of cover 10. However, it should be noted that the electrodes may be disposed in a different location, including the top side of cover 10. From the user point of view, it is easier to use the device when the electrodes are disposed on the top side of the device, although from a safety point of view, when the electrodes are disposed at the bottom side of the device, they are not revealed.

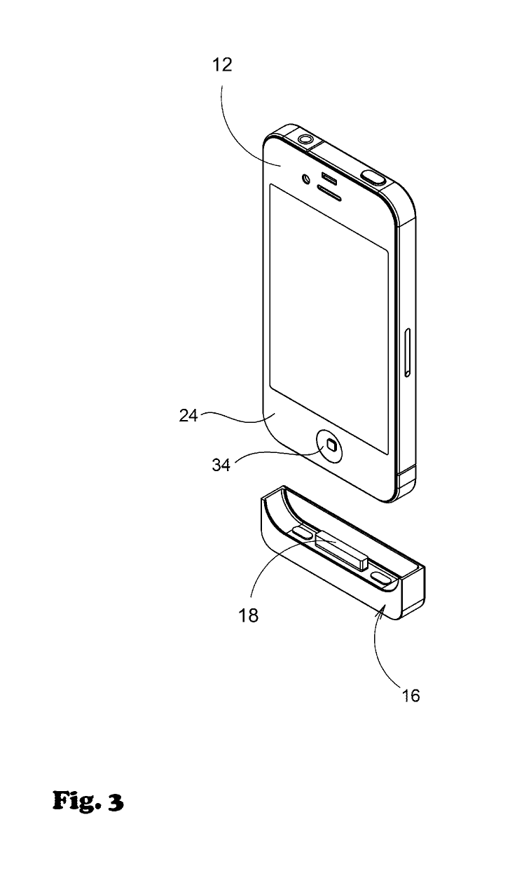

FIG. 3 schematically illustrates an electroshock system, according to another embodiment of the invention.

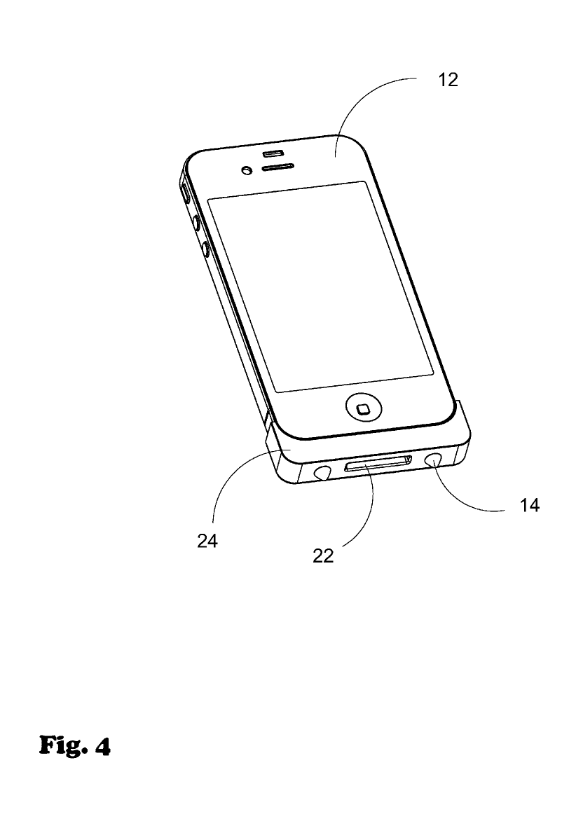

FIG. 4 schematically illustrates a smartphone 12 using the cover 10 of FIG. 3.

The difference between this embodiment (illustrated in FIGS. 3 and 4) and the previous embodiment (illustrated in FIGS. 1 and 2) is that while in this embodiment, the smartphone controls the operation of the electroshock system (e.g., by a dedicated application executed by the smartphone), in the previous embodiment, the smartphone does not control the electroshock system.

An additional difference between the embodiment of FIGS. 1 and 2 to those of FIGS. 3 and 4 is that while in the former embodiment, the cover 10 covers the entire smartphone, in the latter embodiment, the cover 10 covers only the bottom side of the smartphone. As such, in the latter embodiment the activation, buttons are absent.

The application actually provides two objects: employs the smartphone as (a) a controller of the electroshock system, and (b) as a user interface of the electroshock system.

The user interface may be designed to set the parameters of the electroshock system, such as the characteristics of the shocks generated by the system. The controller of the electroshock system is actually the part of the system that provides instructions to the electroshock circuitry 16, such as to activate a shock. This subject matter is further described hereinafter.

Instead of using buttons 20 of the embodiment of FIGS. 1 and 2, the embodiment of FIGS. 3 and 4 employs a user interface provided by the smartphone. Thus, the substitute of the physical buttons 20 is software or physical buttons on the smartphone. As such, in this case there is a data connection between the circuitry 16 and the circuitry of smartphone 12.

The data connection between the electroshock circuitry 16 installed on the cover 10 and the smartphone circuitry allows designing sophisticated user interfaces for operating the system.

For example, a dedicated application to this purpose on the smartphone allows setting the shock voltage. Furthermore, prolonged pressing on one of the smartphone buttons may activate the electroshock system, or put the electroshock system into a standby mode, and so on.

Presently, familiar smartphones use a “sleep” state in which the functionality of the smartphone gets disabled if no activity is carried out with the smartphone for a few minutes. The user terminates the sleep state by pressing one of the physical buttons of the smartphone, and then following the instructions presented on the screen. These limitations do not suit an emergency case, in which the user must immediately activate the electroshock system.

According to one embodiment of the invention, one or more of the physical buttons of the smartphone are used as operational buttons of the electroshock system. For example, once a user presses this button for a “long” period, such as 5 seconds, the electroshock system enters into a standby mode, and alerts the user thereof by playing a sound, vibrating the smartphone, and so on. Then, the user releases this button. Once he presses the button again for a “short” period, such as 1 second, the electroshock system generates a shock.

According to another embodiment of the invention, the touch screen of the smartphone is adapted to be sensitive to a touch even when in the sleep mode. If the user holds his finger on the touch screen for a “long” period, e.g., 5 seconds, the smartphone puts the electroshock system in the standby mode. Once the user releases the screen, and then taps it, a shock is generated.

Actually, these are merely examples of designing a user interface to the electroshock system using a smartphone, and the user interface may be designed in a different manner.

There is some similarity between the urgency to activate an electroshock system and the urgency to activate the camera of a smartphone. The solution of present smartphones to the urgency activation of the camera is providing an icon on the display presented when the user terminates the sleep state (by pressing button 34). Thus, an additional icon for activating the electroshock system may operate in the same manner, i.e., a dedicated button which is available on a sleep mode.

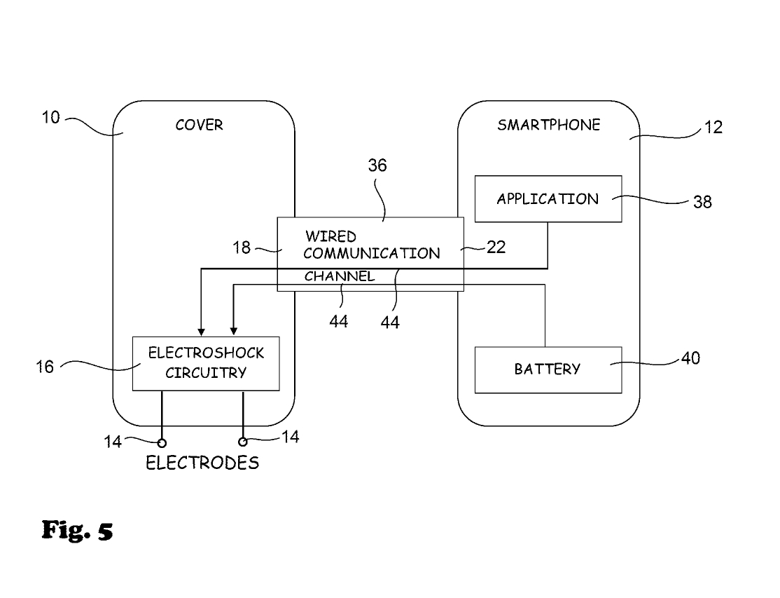

FIG. 5 is a block diagram schematically illustrating the major components of the embodiment of FIGS. 3 and 4.

As illustrated, the electroshock system comprises a cover 10 in which is installed an electroshock circuitry 16, and a software application 38 executed on smartphone 12, which uses the cover.

The power of the smartphone battery 40 is provided to the electroshock circuitry 16 disposed in the cover via a wired communication channel 36, which comprises conductive wires 44 connected by female connector 22 and male connector 18, which connects to the smartphone female connector. The electroshock circuitry administers the shocks through electrodes 14.

In summary, FIG. 5 illustrates a wired communication channel between (a) the software application of the smartphone and the electroshock circuitry disposed on the cover (data communication); and (b) the smartphone battery 40 and the electroshock circuitry 16 (analog communication).

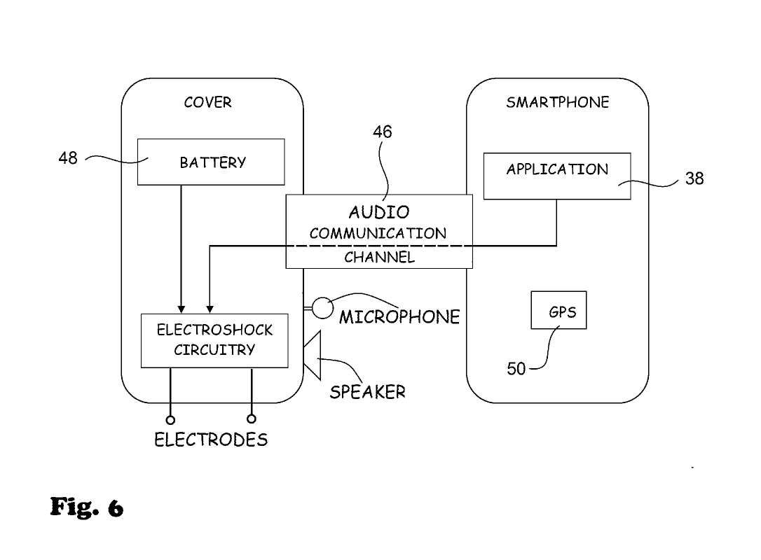

FIG. 6 is a block diagram schematically illustrating the major components of a further embodiment of the invention.

According to this embodiment of the invention, the communicating parties, i.e., the software application and the electroshock disposed on the cover, are communicating with each other by an audio communication channel, in contrast to the embodiment of FIG. 5, in which the communicating parties communicate with each other by a wired communication channel.

The term “audio communication channel” refers herein to a communication channel in which the parties transfer communicated data via an audio signal, such as DTMF (Dual Tone Multi Frequency) signals. An audio communication channel may be bidirectional or unidirectional. In the bidirectional communication channel, each communicated party can send and receive data. In the unidirectional communication channel, only one party sends data, while the other party only receives data.

Presently, smartphones comprise a microphone and speaker, and therefore the software application executed on a smartphone can be adapted to perform audio communication with another party. By using an audio communication channel between the parties, any smartphone can participate in an electroshock system, even if there is no way to provide wired communication between the parties.

In FIG. 6, the cover uses a microphone and speaker, which means that it is adapted to carry out bidirectional communication sessions with the circuitry of the cover. However, the system may be designed to operate with unidirectional communication in which only the smartphone sends data to the circuitry of the cover.

It should be noted that battery 48 is of the cover module of the electroshock system, not of the smartphone. Thus, the power supply is independent.

Additionally, when an emergency takes place, and the user must use the electroshock device, the location of the user can be obtained from the GPS ability of the smartphone, and the location of the user can be transmitted via the cellular telephony to an emergency center, such as the police.

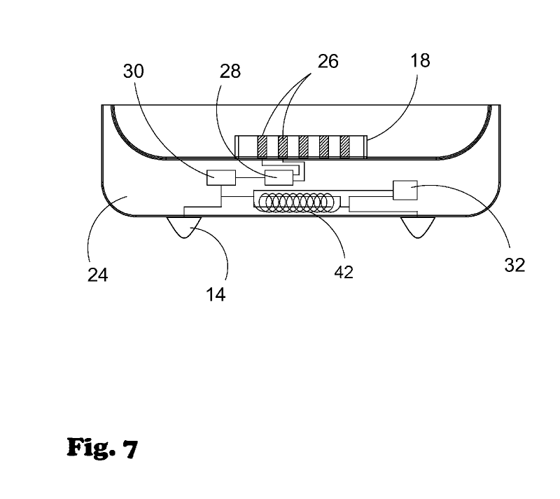

FIG. 7 schematically illustrates an electroshock circuitry, according to one embodiment of the invention.

An input from contacts 26 allows a spark to be produced by electrodes 14. The input from contacts 26 turns on a relay 30, which turns on an oscillator 28. Oscillator 28 (not connected to electrode 14) produces alternating current, supplied to the primary winding of a transformer 42.

Transformer 42 includes primary and secondary windings (not shown) for amplifying the alternating current therebetween. A charge capacitor 32 stores the amplified voltage of the second winding of transformer 42. Charge capacitor 32 may store tens of kilovolts, depending on the ratio between the primary and secondary windings of the transformer. The stored voltage may produce a spark ejected from the electrodes 14.

The longer relay 30 is turned on, the greater is the charging of capacitor 32.

The oscillating rate (frequency) of oscillator 28 may be controlled by a software application executed on the smartphone, by changing an input voltage control to oscillator 28; the input voltage determines the oscillating rate.

In the figures and/or description herein, the following reference numerals (Reference Signs List) have been mentioned:
numeral 10 denotes a smartphone cover;
numeral 12 denotes a smartphone;
numeral 14 denotes an electrode;
numeral 16 denotes an electroshock circuitry;
numeral 18 denotes a male connector;
numeral 20 denotes a physical (in contrast to virtual) activation button of the cover;
numeral 22 denotes a female connector;
numeral 24 denotes a space in the lower side of cover 10, in which electroshock circuitry 16 is disposed;
numeral 26 denotes an electric contact;
numeral 28 denotes an oscillator;
numeral 30 denotes a relay;
numeral 32 denotes a capacitor;
numeral 34 denotes a physical button of the smartphone;
numeral 36 denotes a wired communication channel;
numeral 38 denotes a software application;
numeral 40 denotes a smartphone battery;
numeral 42 denotes a transformer;
numeral 44 denotes a conductive wire;
numeral 46 denotes an audio communication channel;
numeral 48 denotes a battery of cover 10; and
numeral 50 denotes a GPS (Global Positioning System) terminal.

In the description herein, the following references have been mentioned: U.S. Pat. No. 7,986,965 to Kroll et al

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

1. A smartphone electroshock facility, comprising:
a cover (10) of said smartphone (12), for storing therein an electroshock circuitry (16), for generating an electroshock;
two electrodes (14), for administrating said electroshock;
one or more activation buttons, for activating said electroshock circuitry to generate an electroshock;
a safety catch mechanism employing said activation button, for preventing unintentional activation of said electroshock;
a communication channel between said smartphone (12) and said electroshock circuitry (16), for controlling therethrough said electroshock circuitry (16) and activating therethrough said shock; and
a power source (40, 48), for providing electrical power for generating said electroshock.

2. A facility according to claim 1, wherein said activation buttons (20) are disposed on opposite sides of said cover, and said circuitry is adapted to generate a shock if two or more of said buttons are pressed simultaneously, thereby preventing unintentional activation of said electroshock.

3. A facility according to claim 1, wherein said safety catch mechanism includes an adaptation of said electroshock circuitry to sense whether two of said activation buttons (20) are pressed simultaneously for a period of at least three seconds.

4. A facility according to claim 1, wherein said electrodes are disposed in a top side of said cover.

5. A facility according to claim 1, wherein said electrodes are disposed in a bottom side of said cover.

6. A facility according to claim 1, wherein said power source is a battery (48) disposed in said cover.

7. A facility according to claim 1, wherein said power source is a battery (40) of said smartphone (12).

8. A facility according to claim 1, wherein said one or more activation buttons are physical buttons (20).

9. A facility according to claim 1, wherein said one or more activation buttons are physical buttons (34) of said smartphone.

10. A facility according to claim 1, wherein said one or more activation buttons are virtual buttons of said smartphone.

11. A facility according to claim 1, wherein said cover (10) covers only a lower part of said smartphone, thereby allowing connecting thereof only under a condition of expected danger, resulting in prevention of unintentional activation of an electroshock.

12. A facility according to claim 1, wherein said safety catch mechanism is embodied as pressing said activation buttons in a predetermined order and period.

13. A facility according to claim 1, further comprising a software application (38) executed by said smartphone (12), said application (38) communicating with said electroshock circuitry (16) via said communication channel.

14. A facility according to claim 1, wherein said communication channel is wired (36).

15. A facility according to claim 1, wherein said communication channel is wireless.

16. A facility according to claim 15, wherein said wireless communication channel is an audio communication channel (46).

17. A facility according to claim 16, wherein said audio communication channel employs DTMF signals.

18. A facility according to claim 13, wherein said safety catch mechanism comprises an adaptation of said software application to sense whether a user holds his finger at the same place on a display of said smartphone while in a sleep state for a predetermined period.

19. A facility according to claim 13, wherein said software application is adapted to send upon activating said electroshock an alerting message detailing a location of said smartphone to a predetermined addressee.

20. A facility according to claim 13, wherein said software application controls a voltage generated between the electrodes (14) via a voltage in the input of an oscillator (28) of said electroshock circuitry (16).

21. A facility according to claim 13, further adapted to: upon generating said electroshock, obtaining a location of said smartphone, and transmitting an alert to a predefined destination.

22. A facility according to claim 21, wherein said transmitting is carried out via an SMS message.

23. A facility according to claim 21, wherein said alert comprises information of said location.

24. A facility according to claim 13, wherein said application (38) being further adapted to generate a sound alert upon generating said electroshock.
